(19) United States
(12) Patent Application Publication
(10) Pub. No.: US 2026/0070628 A1
(43) Pub. Date: Mar. 12, 2026

(54) AIR PURGING DISC BRAKE MASTER CYLINDER ASSEMBLY

(71) Applicant: Fox Factory, Inc., Duluth, GA (US)

(72) Inventor: Bill Becker, Aptos, CA (US)

(21) Appl. No.: 18/828,943

(22) Filed: Sep. 9, 2024

(51) Int. Cl. B62L 3/02; F15B 1/26; F15B 7/08

(52) U.S. Cl. CPC B62L 3/023; F15B 1/26; F15B 7/08

(57) ABSTRACT

An air purging disc brake master cylinder assembly is provided. A master cylinder reservoir housing is oriented vertically relative to the disc brake master cylinder assembly. A bladder cap member is secured to a bladder member and the bladder member is received within the master cylinder reservoir housing. A bleed threaded aperture is provided in the bladder cap member in order to allow accumulated air bubbles in the master cylinder reservoir housing to escape to the atmosphere. A vent hole is also provided in the bladder cap member allowing direct communication of outside air within the bladder member.

### BACKGROUND OF THE INVENTION

### Technical Field

This invention relates generally to a disc brake master cylinder assembly and more particularly to a disc brake master cylinder assembly having an air purging aperture.

### State of the Art

The average brake angle on a bike, including mountain bikes, is about 30 degrees tipped down from a horizontal plane parallel to a horizontal ground plane. A master cylinder reservoir can be orientated in a number of orientations, some of which cause air bubbles to form within the master cylinder reservoir when checked and/or refilled with brake fluid. A rider generally adjusts their brake lever angle every time they check brake fluid height and/or bleed their brakes. As a result, air bubbles can accumulate and cause undesirable effects in braking performance.

Bikes are often stored vertically or upside down. Generally, it is not preferred to store vertically or upside down because it can allow air into the brake caliper, or at least into the brake hose. The master cylinder reservoir may drain, and air bubbles can float to the top of the master cylinder reservoir.

Accordingly, there is a need for a convenient way to check brake fluid height and bleed brakes without causing accumulation of air bubbles within the brake fluid system and to avoid the rider from having to readjust their brake lever angle every time they go to check brake fluid height or bleed their brakes. There is also a need for a leakproof and air-free brake fluid system in order to prevent frequent rebleeding of the brake fluid system.

### SUMMARY OF THE INVENTION

An embodiment includes a disc brake master cylinder assembly comprising: a master cylinder reservoir housing extending upwardly from a disc brake master cylinder main body; a bladder member received within a brake fluid reservoir of the master cylinder reservoir housing; a bladder cap member secured to the bladder member, the bladder cap coupled to the master cylinder reservoir housing; and a vent hole provided in a sidewall of the bladder cap member, wherein the vent hole is configured to allow direct communication of outside air within the bladder member.

A hold down plate may be provided on the bladder member and secured to the bladder cap member. The bladder member and the hold down plate may be arranged with coplanar flat surfaces. The vent hole may be positioned above a flat compression zone defined by the coplanar flat surfaces. The disc brake master cylinder assembly may further comprise a pair of bladder cap screws securing the bladder cap member to the master cylinder reservoir housing. The bladder cap member and the bladder member may have stepped portions, wherein the stepped portions provide a flat surface of the hold down plate to be flush with a flat surface of the bladder member.

Another embodiment includes a method of using a disc brake master cylinder assembly comprising: coupling a disc brake master cylinder assembly to a brake system of a vehicle, the disc brake master cylinder assembly comprising: a master cylinder reservoir housing extending upwardly from a disc brake master cylinder main body; a bladder member received within a brake fluid reservoir of the master cylinder reservoir housing; a bladder cap member secured to the bladder member, the bladder cap coupled to the master cylinder reservoir housing; and a vent hole provided in a sidewall of the bladder cap member; expanding or contracting the bladder member in response to air entering or leaving an inner volume of the bladder member through the vent hole as brake fluid within the brake fluid reservoir is displaced during brake system operation; and reducing air within the brake fluid reservoir in response to the expanding and contracting of the bladder member, thereby inhibiting air introduction into a brake line of the brake system.

The brake fluid within the brake fluid reservoir may be displaced in response to thermal expansion, warping of a brake rotor, brake pad wear and/or by pistons in the caliper housing. The disc brake master cylinder assembly may further comprise a hold down plate provided on the bladder member and secured to the bladder cap member. The bladder member and the hold down plate may be arranged with coplanar flat surfaces. The vent hole may be positioned above a flat compression zone defined by the coplanar flat surfaces. The hold down plate may comprise steel. The bladder member may comprise an elastomer.

Another embodiment includes a disc brake master cylinder assembly comprising: a master cylinder reservoir housing extending upwardly from a disc brake master cylinder main body; a bladder system assembly provided in the master cylinder reservoir housing; a bladder member received within a brake fluid reservoir of the master cylinder reservoir housing; a bladder cap member secured to the bladder member; a hold down plate provided on the bladder member and secured to the bladder cap member; a pair of bladder cap screws securing the bladder cap member to the master cylinder reservoir housing; a bleed threaded aperture provided through the bladder cap member and communicating with the brake fluid reservoir through the hold down plate; a bleed screw provided within the bleed threaded aperture; and a vent hole provided in a sidewall of the bladder cap member, wherein the vent hole is configured to allow direct communication of outside air within the bladder member.

The bladder cap member may be provided with a pair of mounting bosses to threadingly receive the pair of bladder cap screws. The bladder cap member may secure the bladder member with the master cylinder reservoir housing via the pair of bladder cap screws. The bladder member and the hold down plate may be arranged with coplanar flat surfaces. The vent hole may be positioned above a flat compression zone defined by the coplanar flat surfaces. The hold down plate may comprise steel. The bladder member may comprise an elastomer.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a disc brake master cylinder assembly, according to an embodiment;

FIG. 2 is an end perspective view of a disc brake master cylinder assembly according to an embodiment;

FIG. 3A is a perspective view of a bladder cap member according to an embodiment;

FIG. 3B is a perspective cross-sectional view of a bladder cap member according to an embodiment;

FIG. 4 is a perspective sectional view of a disc brake master cylinder assembly according to an embodiment; and

FIG. 5 is a flow chart depicting a method of assembling a disc brake master cylinder assembly according to an embodiment.

### DETAILED DESCRIPTION OF EMBODIMENTS OF THE INVENTION

As discussed above, embodiments of the present invention relate to a disc brake master cylinder bleed assembly. The master cylinder reservoir housing is in a vertical orientation when installed on a bike on flat ground. The present invention allows air bubbles to naturally rise and purge out of a bleed threaded aperture when a rider checks brake fluid height, topping off or filling with a “screw in” funnel.

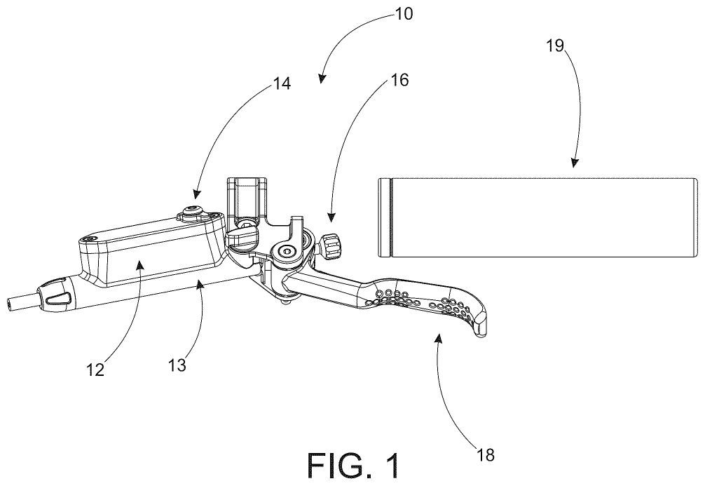

FIGS. 1, 2 and 4 show a disc brake master cylinder assembly 10 having a master cylinder reservoir housing 12 and a disc brake master cylinder main body 13. Bladder system assembly 14 is provided in master cylinder reservoir housing 12. In FIG. 1, a brake lever reach adjustment screw 16 is provided to adjust a position of brake lever 18 relative to a handlebar grip 19.

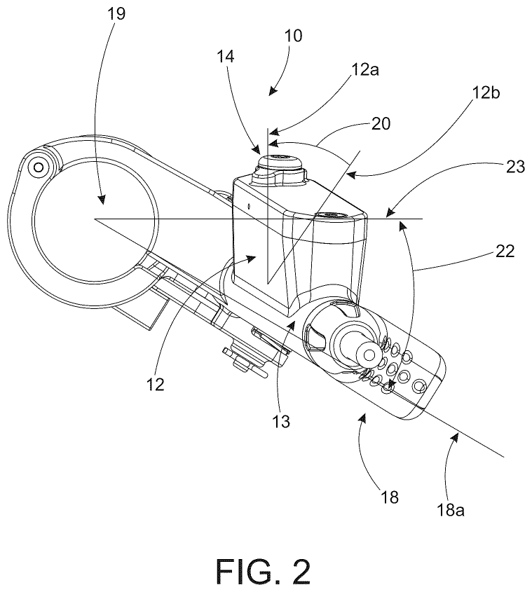

In FIG. 2, master cylinder reservoir housing 12 extending generally vertically upward from the disc brake master cylinder main body 13 of disc brake master cylinder assembly 10.

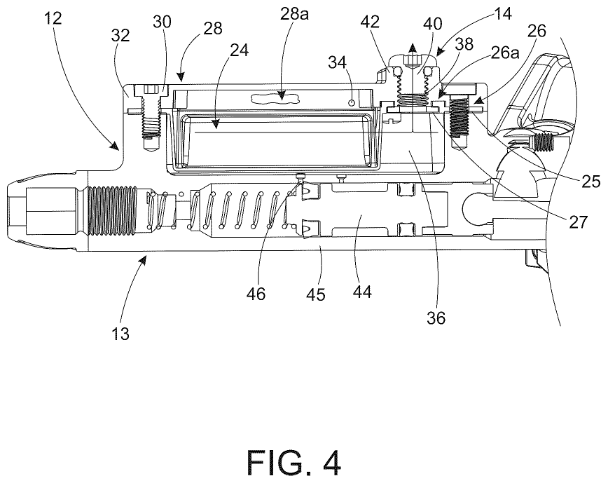

Master cylinder reservoir housing 12 is generally positioned along a vertically upwardly extending axis 12a that is positioned at reservoir housing angle 20 which is about 30 degrees from a perpendicular axis 12b extending from a brake lever plane 18a defined between brake lever 18 and handlebar grip 19. This orientation is to ensure that when brake fluid reservoir 36 (See FIG. 4) of master cylinder reservoir housing 12 is filled with brake fluid to the top of the brake fluid reservoir 36, it fills up level relative to master cylinder reservoir housing 12. Further, lever angle 22 is about 30 degrees down from a horizontal plane 23. It will be understood that horizontal plane 23 is parallel to a surface that the vehicle travels on. Bladder system assembly 14 allows air bubbles to naturally purge out when at reservoir angle 20.

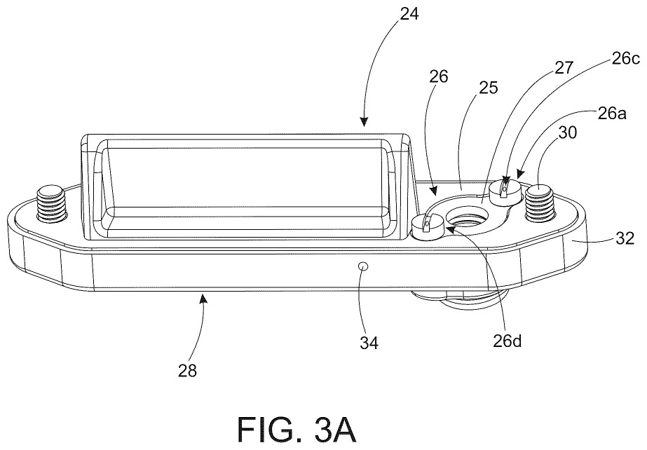

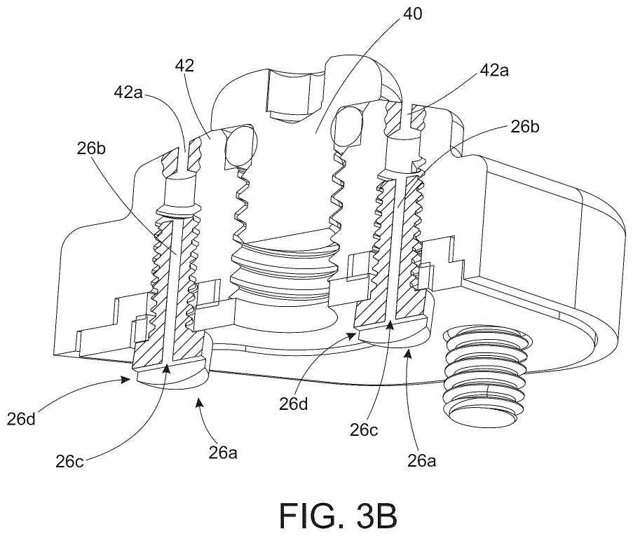

In FIGS. 3A and 3B, a bladder member 24 is provided on a rigid bladder cap member 28. Bladder member 24 and hold down plate 26 are arranged with coplanar flat surfaces 25 and 27, respectively, and are secured to bladder cap member 28. Bladder member 24 and hold down plate 26 are sealingly secured to bladder cap member 28 by one or more slotted screws 26a to prevent any fluid leakage. Bladder cap member 28 is provided with mounting bosses 32 on opposite ends thereof and receive respective bladder cap screws 30. A breather or vent hole 34 is provided in a sidewall of bladder cap member 28. Bladder cap member 28 may comprise an inner air volume 28a (See FIG. 4) that communicates with atmospheric air. Hold down plate 26 and bladder member 24 having coplanar flat surfaces 27 and 25, respectively, provide a smooth flat surface for the air bubbles to purge out of brake fluid reservoir 36 as reservoir 36 is being filled or topped off at a top portion of the brake fluid reservoir 36. Breather or vent hole 34 is positioned above a flat compression zone defined by coplanar flat surfaces 25 and 27 of bladder member 24 and hold down plate 26 which allows atmospheric air to communicate with an inner volume of the bladder member 24, and freely expand or contract the bladder member 24 as brake fluid is displaced due to thermal expansion, warping of a brake rotor, brake pad wear and/or by pistons in the caliper housing (not shown). Hold down plate 26, may be constructed of steel and/or any suitable material, is fastened to compress bladder member 24 (bladder member 24 may comprise an elastomer, such as rubber or another material) to bladder cap member 28 and prevents fluid leaks between bladder member 24 and bladder cap member 28.

As shown in FIG. 4, bladder cap member 28 is shown secured to master cylinder reservoir housing 12 via bladder cap screws 30. Bladder cap screws 30 are threadingly received in mounting bosses 32 and threadingly secured to master cylinder reservoir housing 12 to compress bladder member 24 and prevent fluid from leaking between bladder member 24 and bladder cap member 28 and out breather or vent hole 34.

Bladder cap member 28 receives bladder member 24, both of which have stepped portions 26b in order to have assembled hold down plate 26 having flat surface 27 flush with flat surface 25 of bladder member 24. The hold down plate 26 compresses bladder member 24 to bladder cap member 28 and prevents fluid leaks between bladder member 24 and bladder cap member 28.

Brake fluid reservoir 36 is provided within master cylinder reservoir housing 12. Brake fluid reservoir 36 is filled with brake fluid up to the top portion of the brake fluid reservoir 36 through bleed threaded aperture 38 when bleed screw 40 is removed. Bleed threaded aperture 38 is provided within bleeder cup portion 42 of bladder cap member 28. Master cylinder piston 44 is slidably received within cylinder housing 45 (See FIG. 4). Master cylinder piston 44 and cylinder housing 45 are positioned below brake fluid reservoir 36 of master cylinder reservoir housing 12. Cylinder housing 45 communicates with brake fluid reservoir 36 via a first master cylinder transfer port 46a and a second master cylinder transfer port 46b. The second master cylinder transfer port 46b allows air out and fluid in behind primary piston seal 44a in the resting state of the master cylinder piston 44.

In another embodiment (not shown), a symmetric exterior profile of a bladder cap member allows a bladder cap member to be rotated about 180 degrees so that it operates and seals on either the left or right-side disc brake master cylinder assembly.

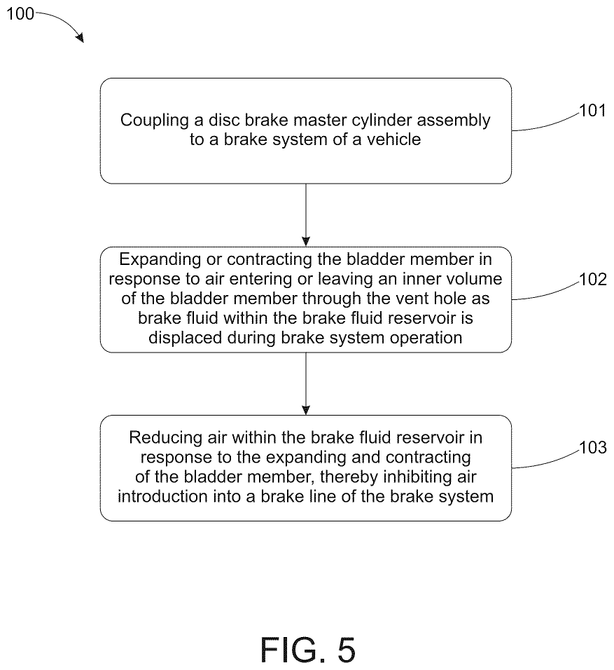

Referring to the drawings, FIG. 5 depicts a method 100 of using a disc brake master cylinder assembly. The method 100 comprises: coupling a disc brake master cylinder assembly to a brake system of a vehicle, the disc brake master cylinder assembly comprising: a master cylinder reservoir housing extending upwardly from a disc brake master cylinder main body; a bladder member received within a brake fluid reservoir of the master cylinder reservoir housing; a bladder cap member secured to the bladder member, the bladder cap coupled to the master cylinder reservoir housing; and a vent hole provided in a sidewall of the bladder cap member (Step 101); expanding or contracting the bladder member in response to air entering or leaving an inner volume of the bladder member through the vent hole as brake fluid within the brake fluid reservoir is displaced during brake system operation (Step 102); and reducing air within the brake fluid reservoir in response to the expanding and contracting of the bladder member, thereby inhibiting air introduction into a brake line of the brake system (Step 103).

The brake fluid within the brake fluid reservoir may be displaced in response to thermal expansion, warping of a brake rotor, brake pad wear and/or by pistons in the caliper housing. The disc brake master cylinder assembly may further comprise a hold down plate provided on the bladder member and secured to the bladder cap member. The bladder member and the hold down plate may be arranged with coplanar flat surfaces. The vent hole may be positioned above a flat compression zone defined by the coplanar flat surfaces. The hold down plate may comprise steel. The bladder member may comprise an elastomer.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A disc brake master cylinder assembly comprising:
a master cylinder reservoir housing extending upwardly from a disc brake master cylinder main body;
a bladder member received within a brake fluid reservoir of the master cylinder reservoir housing;
a bladder cap member secured to the bladder member, the bladder cap coupled to the master cylinder reservoir housing; and
a vent hole provided in a sidewall of the bladder cap member, wherein the vent hole is configured to allow direct communication of outside air within the bladder member.

2. The disc brake master cylinder assembly of claim 1, further comprising a hold down plate provided on the bladder member and secured to the bladder cap member.

3. The disc brake master cylinder assembly of claim 2, wherein the bladder member and the hold down plate are arranged with coplanar flat surfaces.

4. The disc brake master cylinder assembly of claim 3, wherein the vent hole is positioned above a flat compression zone defined by the coplanar flat surfaces.

5. The disc brake master cylinder assembly of claim 1, further comprising a pair of bladder cap screws securing the bladder cap member to the master cylinder reservoir housing.

6. The disc brake master cylinder assembly of claim 2, wherein the bladder cap member and the bladder member have stepped portions, wherein the stepped portions provide a flat surface of the hold down plate to be flush with a flat surface of the bladder member.

7. A method of using a disc brake master cylinder assembly comprising:
coupling a disc brake master cylinder assembly to a brake system of a vehicle, the disc brake master cylinder assembly comprising:
a master cylinder reservoir housing extending upwardly from a disc brake master cylinder main body;
a bladder member received within a brake fluid reservoir of the master cylinder reservoir housing;
a bladder cap member secured to the bladder member, the bladder cap coupled to the master cylinder reservoir housing; and
a vent hole provided in a sidewall of the bladder cap member;
expanding or contracting the bladder member in response to air entering or leaving an inner volume of the bladder member through the vent hole as brake fluid within the brake fluid reservoir is displaced during brake system operation; and
reducing air within the brake fluid reservoir in response to the expanding and contracting of the bladder member, thereby inhibiting air introduction into a brake line of the brake system.

8. The method of claim 7, wherein the brake fluid within the brake fluid reservoir is displaced in response to thermal expansion, warping of a brake rotor, brake pad wear and/or by pistons in the caliper housing.

9. The method of claim 7, wherein the disc brake master cylinder assembly further comprises a hold down plate provided on the bladder member and secured to the bladder cap member.

10. The method of claim 9, wherein the bladder member and the hold down plate are arranged with coplanar flat surfaces.

11. The method of claim 10, wherein the vent hole is positioned above a flat compression zone defined by the coplanar flat surfaces.

12. The method of claim 9, wherein the hold down plate comprises steel.

13. The method of claim 7, wherein the bladder member comprises an elastomer.

14. A disc brake master cylinder assembly comprising:
a master cylinder reservoir housing extending upwardly from a disc brake master cylinder main body;
a bladder system assembly provided in the master cylinder reservoir housing;
a bladder member received within a brake fluid reservoir of the master cylinder reservoir housing;
a bladder cap member secured to the bladder member;
a hold down plate provided on the bladder member and secured to the bladder cap member;
a pair of bladder cap screws securing the bladder cap member to the master cylinder reservoir housing;
a bleed threaded aperture provided through the bladder cap member and communicating with the brake fluid reservoir through the hold down plate;
a bleed screw provided within the bleed threaded aperture; and
a vent hole provided in a sidewall of the bladder cap member, wherein the vent hole is configured to allow direct communication of outside air within the bladder member.

15. The disc brake master cylinder assembly of claim 14, wherein the bladder cap member is provided with a pair of mounting bosses to threadingly receive the pair of bladder cap screws.

16. The disc brake master cylinder assembly of claim 14, wherein the bladder cap member secures the bladder member with the master cylinder reservoir housing via the pair of bladder cap screws.

17. The disc brake master cylinder assembly of claim 14, wherein the bladder member and the hold down plate are arranged with coplanar flat surfaces.

18. The disc brake master cylinder assembly of claim 17, wherein the vent hole is positioned above a flat compression zone defined by the coplanar flat surfaces.

19. The disc brake master cylinder assembly of claim 14, wherein the hold down plate comprises steel.

20. The disc brake master cylinder assembly of claim 14, wherein the bladder member comprises an elastomer.
